(19) United States
(12) Patent Application Publication
(10) Pub. No.: US 2001/0005449 A1
(43) Pub. Date: Jun. 28, 2001

(54) Multichannel image compression device and its method

(76) Inventor: Eiki Obara, Hiki-gun (JP)

Correspondence Address: Pillsbury Madison & Sutro, LLP, East Tower, Ninth Floor, 1100 New York Avenue, N.W., Washington, DC, 20005-3918, US

(21) Appl. No.: 09/748,236

(22) Filed: Dec. 27, 2000

(30) Foreign Application Priority Data
Dec. 27, 1999 (JP) 11-370996

(51) Int. Cl. H04N 5/76; H04N 7/26; H04N 5/91; H04N 5/225

(52) U.S. Cl. 386/109; 386/117

(57) ABSTRACT

A multichannel image compression device comprises recording means for storing digital images on a plurality of channels in frames channel by channel into memories, control means for performing control in such a manner that the digital images stored by the recording means into the memories increase in number on a specific channel, and compression means for subjecting the digital images recorded by the recording means into the memories to compression coding by correlating frames channel by channel.

### CROSS-REFERENCE TO RELATED APPLICATIONS

This application is based upon and claims the benefit of priority from the prior Japanese Patent Application No. 11-370996, filed Dec. 27, 1999, the entire contents of which are incorporated herein by reference.

### BACKGROUND OF THE INVENTION

This invention relates to a digital image compression device, and more particularly to a multichannel image compression device for compressing digital images on a plurality of channels and to its method.

As is generally known, when images are recorded to keep watch with a camera or the like, a recording medium with a large capacity is required to record the images as they are, because the recording is usually done for many hours.

Since images in such watching are not necessarily recorded continuously, they are often recorded intermittently to reduce the recording capacity. This type of video recording is sometimes called time lapse video recording.

In use for watching, there are often a plurality of watch points. In such a case, the watch points are photographed intermittently in sequence and the multichannel intermittent images are transmitted or recorded.

On the other hand, with recent advances in digital technology, images have been processed in digital form. To obtain digital images, it is necessary to record a tremendous volume of information.

To decrease the amount of information, image compression techniques for compressing images by correlating images, including the JPEG (Joint Photographic Experts Group) and MPEG (Moving Picture Image Coding Experts Group) techniques, have rapidly been popularized.

When time lapse video recording of a plurality of places is effected using such digital techniques, the images can be compressed making use of the correlation between images. In this case, time lapse video recording using the JPEG standard is known as image compression means.

Since the JPEG standard is a compression method disadvantageous in that the compression ratio is not very high.

On the other hand, use of MPEG techniques makes it possible to correlate frames. In the case of a multichannel, however, since the images in front of and behind the channel to be switched come from other watch points, correlating the frames without any modification leads to the disadvantage of failing to perform efficient image compression.

To overcome these problems, the applicant has filed Japanese Patent Application No. 11-276922, which has disclosed an image compression device which has an image buffer memory for each channel and correlates frames channel by channel, thereby effecting coding and compression according to, for example, the MPEG standard.

### BRIEF SUMMARY OF THE INVENTION

The object of the present invention is to provide not only a multichannel image compression device by further improving the above-described image compression device to make the device suitable for a case where more careful watch is required on the image on a predetermined specific channel or on a specific channel giving a warning that an abnormality has occurred, but also its method.

The foregoing object is accomplished by providing a multichannel image compression device comprising: recording section for storing digital images on a plurality of channels in frames channel by channel into memories; control section for performing control in such a manner that the digital images stored by the recording section into the memories increase in number on a specific channel; and compression section for subjecting the digital images recorded by the recording section into the memories to compression coding by correlating frames channel by channel.

The foregoing object is further accomplished by providing a multichannel image compression method comprising: a recording step of storing digital images on a plurality of channels in frames channel by channel into memories; a control step of performing control in such a manner that the digital images stored in the memories in the recording step increase in number on a specific channel; and a compression step of subjecting the digital images recorded in the memories in the recording step to compression coding by correlating frames channel by channel.

With the above configuration and method, because control is performed in such a manner that, when digital images on a plurality of channels are stored in memories in frames channel by channel, the digital images stored in the memories increase in number on a specific channel, more careful watch can be kept on the image on a predetermined specific channel or on a specific channel giving a warning that an abnormality has occurred.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram to help explain a multichannel image compression device and its method according to a first embodiment of the present invention;

FIGS. 2A to 2F are illustrations to help explain the operation of the first embodiment;

FIG. 3 is a block diagram to help explain a multichannel image compression device and its method according to a second embodiment of the present invention; and

FIGS. 4A to 4G are illustrations to help explain the operation of the second embodiment.

### DETAILED DESCRIPTION OF THE INVENTION

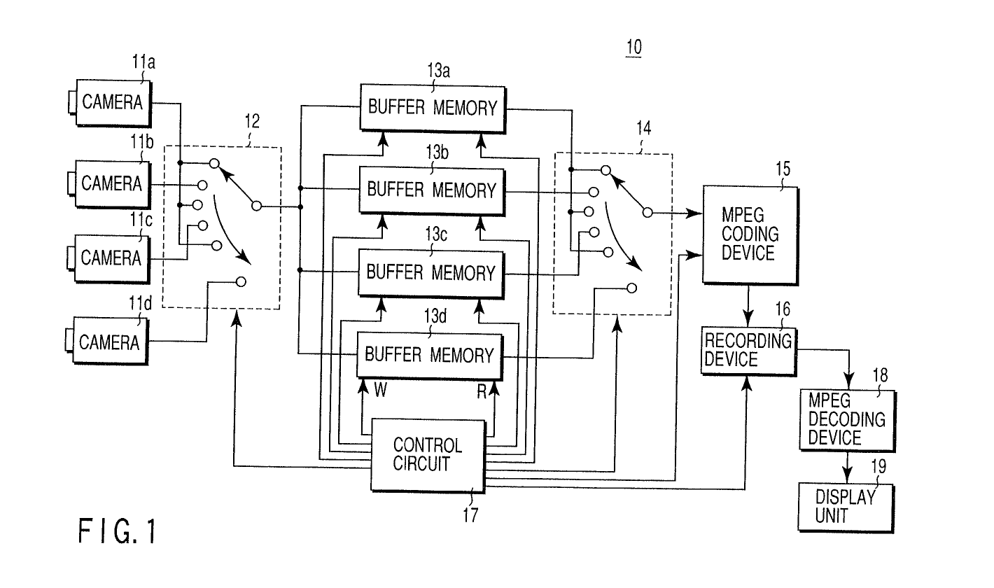

Hereinafter, referring to the accompanying drawings, a first embodiment of the present invention will be explained. FIG. 1 shows an image recording device 10, which will be explained in the first embodiment. The first embodiment illustrates a case where places needing more careful watch have been predetermined. In this case, it is assumed that there are four watch points and, of these places, the first place has to be watched more carefully than the others.

The image recording device 10 of FIG. 1 comprises cameras 11a, 11b, 11c, and 11d provided in four places needing watch, a selector circuit 12 for selecting one of the images picked up by these cameras 11a to 11d, buffer memories 13a, 13b, 13c, and 13d for storing the image selected by the selector circuit 12 temporarily frame by frame in such a manner that the selected image corresponds to each channel or each of the cameras 11a to 11d, a selector circuit 14 for selecting one of the images stored in the buffer memories 13a to 13d, an MPEG coding device 15 for coding the image on the channel selected by the selector 14 according to the MPEG standard, a recording device 16 for recording the image MPEG-coded by the MPEG coding device 15 in a DVD (Digital Versatile Disc) or another type of recording medium that enables recording and reproduction of data, and a control circuit 17 for supervising control of the selector circuits 12, 14, buffer memories 13a to 13d, MPEG coding device 15, and recording device 16.

The image on each channel compressed and recorded in the recording device 16 is selectively subjected to an MPEG decoding process at an MPEG decoding device 18. The resulting image is displayed on an display unit 19.

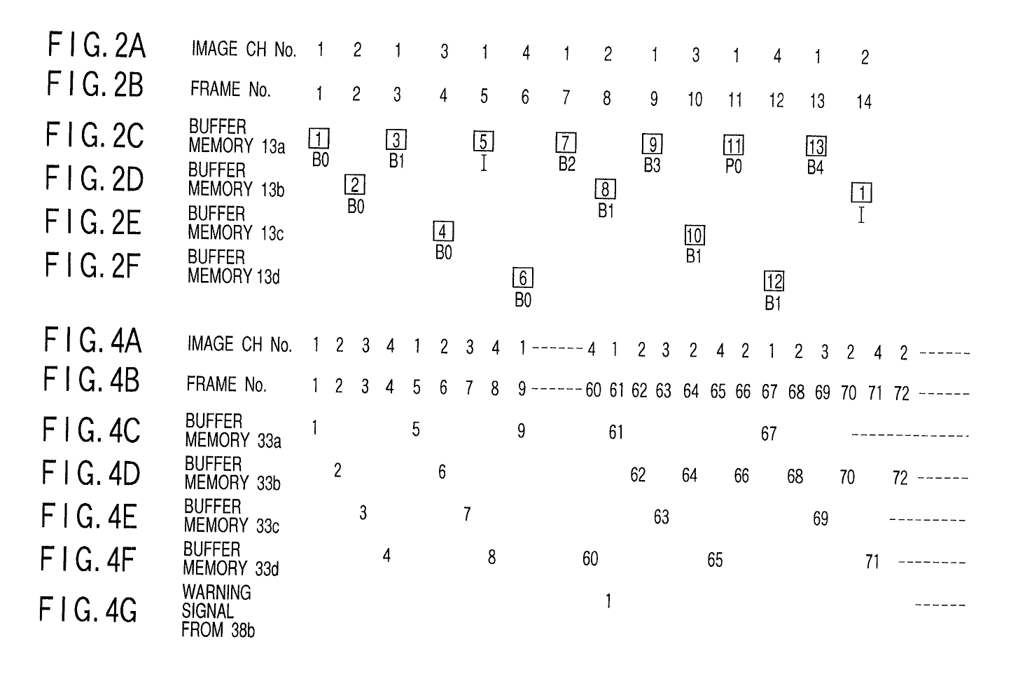

The operation of the image recording device 10 with the aforementioned configuration will be explained by reference to FIGS. 2A to 2F. FIG. 2A shows the channel numbers of the images selected by the selector circuit 12. In this case, the images obtained from the cameras 11a to 11d are allocated the channel numbers 1 to 4.

FIG. 2B shows the frame numbers of the images selected by the selector circuit 12. In this case, the image for each frame obtained from the selector circuit 12 is allocated a frame number in sequence, regardless of the cameras 11a to 11d, or the channels.

FIGS. 2C to 2F show the frame numbers of the images stored in the buffer memories 13a to 13d. Under each frame number, the type (B, P, or I) of the pictures has been written which constitute a GOP (Group Of Picture), a unit of encoding, in subjecting the images stored in the buffer memories 13a to 13d to MPEG coding.

The common terminal on the right side of the selector circuit 12 is making the rounds repeatedly in such a manner that the terminal is switched so as to touch the individual contacts on the left side, starting from the top to the bottom sequentially and, when it reaches the bottom contact, then returns to the top and is switched so as to touch them from the top to bottom in sequence again.

As a result, the selector circuit 12 is switched in such a manner that it selects the image from the camera 11a every other frame. Then, the image from the camera 11a selected by the selector circuit 12 is stored in the buffer memory 13a.

Specifically, in the case of frame number 1, the selector circuit 12 comes to select the image on channel number 1 and the image photographed by the camera 11a is stored in the buffer memory 13a. In the case of frame number 2, the selector circuit 12 comes to select the image on channel number 2 and the image photographed by the camera 11b is stored in the buffer memory 13b.

Next, in the case of frame number 3, the selector circuit 12 comes to select the image on channel number 1 again and the image photographed by the camera 11a is stored in the buffer memory 13a. In the case of frame number 4, the selector circuit 12 comes to select the image on channel number 3 and the image photographed by the camera 11c is stored in the buffer memory 13c.

Then, in the case of frame number 5, the selector circuit 12 comes to select the image on channel number 1 again and the image photographed by the camera 11a is stored in the buffer memory 13a. In the case of frame number 6, the selector circuit 12 comes to select the image on channel number 4 and the image photographed by the camera 11d is stored in the buffer memory 13d.

Then, in the case of frame number 7, the selector circuit 12 comes to select the image on channel number 1 again and the image photographed by the camera 11a is stored in the buffer memory 13a. In the case of frame number 8, the selector circuit 12 comes to select the image on channel number 2 and the image photographed by the camera 11b is stored in the buffer memory 13b.

Similarly, from this time on, the images photographed by the individual cameras 11a to 11d are stored in the respective buffer memories 13a to 13d. In this case, the images with frame numbers 1, 3, 5, 7, 9, 11, 13, . . . are stored in the buffer memory 13a. That is, as shown in FIGS. 2C to 2F, the number of the images stored in the buffer memory 13a is triple as many as that in each of the buffer memories 13b to 13d.

Then, the selector circuit 14 supplies the images stored in the buffer memories 13a to 13d to the MPEG coding device 15, which subjects the images to MPEG coding. In this case, it is assumed that the number N of pictures constituting one GOP, a unit of MPEG coding, is 15. For example, for channel number 1, the pictures B0, B1, I, B2, B3, P0, B4, . . . are obtained as written under the respective frame numbers in FIG. 2C.

For each of the other channel numbers 2 to 4, the pictures B0, B1, I, . . . are obtained as written under the respective frame numbers in FIGS. 2D to 2F.

Consequently, if the number of pictures constituting one GOP is the same on each channel, the image on channel number 1 will be MPEG-coded at a speed three times as fast as the image on each of the other channels 2 to 4. That is, the degree of watch on the channel with channel number 1 can be increased as compared with the channels with the other channel numbers 2 to 4.

In the first embodiment, explanation has been given about the case where the channel on which the degree of watch needs to be increased has been determined beforehand. With the present invention, however, the channel on which the degree of watch needs to be increased may be changed appropriately according to the conditions.

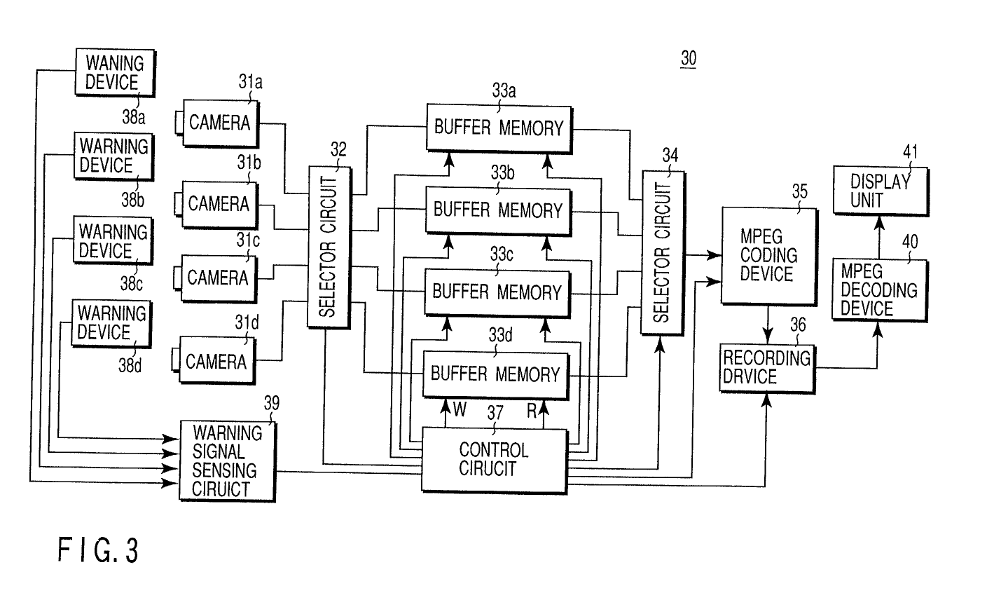

FIG. 3 shows a second embodiment of the present invention which keeps close watch on the place, because one of the places being under watch has given a warning.

The image recording device 30 of FIG. 3 comprises cameras 31a, 31b, 31c, and 31d provided in four places needing watch, a selector circuit 32 for selecting one of the images picked up by these cameras 31a to 31d, buffer memories 33a, 33b, 33c, and 33d for storing the image selected by the selector circuit 32 temporarily frame by frame in such a manner that the selected image corresponds to each channel, or each of the cameras 31a to 31d, a selector circuit 34 for selecting one of the images stored in the buffer memories 33a to 33d, an MPEG coding device 35 for coding the image on the channel selected by the selector 34 according to the MPEG standard, a recording device 36 for recording the image MPEG-coded by the MPEG coding device 35, a control circuit 37 for supervising control of the selector circuits 32, 34, buffer memories 33a to 33d, MPEG coding device 35, and recording device 36, warning devices 38a, 38b, 38c, and 38d provided near the four cameras 31a to 31d respectively, and a warning signal sensing circuit 39 for sensing the warning signal issued from these warning devices 38a to 38d and sending information on the channel issuing the warning signal and other information to the control circuit 37.

The image on each channel compressed and recorded in the recording device 36 is selectively subjected to an MPEG decoding process at an MPEG decoding device 40. The resulting image is displayed on an display unit 41.

The operation of the image recording device 30 with the aforementioned configuration will be explained by reference to FIGS. 4A to 4G. In the normal state, the selector switch 32 is connected to the cameras 31a to 31d sequentially and the images picked up by the cameras 31a to 31d are stored in the buffer memories 33a to 33d, respectively.

When the images obtained from the cameras 31a to 31d are allocated channel numbers 1 to 4 as shown in FIG. 4A and the images selected by the selector circuit 32 are allocated consecutive frame numbers as shown in FIG. 4B, the images with channel numbers 1 to 4 are selected by the selector circuit 32 sequentially as shown in FIGS. 4C to 4F and stored as the images with frame numbers 1 to 4 in the buffer memories 33a to 33d.

Next, the images with channel numbers 1 to 4 are selected by the selector circuit 32 sequentially and are stored as the images with frame numbers 5 to 8 in the buffer memories 33a to 33d. Similarly, from this point on, the images with channel numbers 1 to 4 are stored in the buffer memories 33a to 33d, respectively.

Here, it is assumed that the number N of pictures constituting one GOP, a unit of coding in MPEG-2, is 15. In this case, when 15 images with frame numbers 1, 5, 9, . . . have been stored in the buffer memory 33a, they are read via the selector circuit 34 into the MPEG coding device 35, which subjects these images to MPEG coding, producing I, B, and P pictures. These resulting pictures are stored in the recording device 36.

The images stored in the buffer memories 33b to 33d are also read via the selector circuit 34 similarly into the MPEG coding device 35, which codes the images channel by channel. The resulting pictures are stored in the recording device 36.

As described above, the images on the individual channels are normally subjected to MPEG coding uniformly and then the resulting pictures are stored. When one of the warning devices 38a to 38d has given a warning signal that indicates the occurrence of an abnormality, the operation changes.

Specifically, as shown in FIG. 4G, it is assumed that the warning device 38b gives a warning signal at the time when, for example, the selector circuit 32 has selected the image with frame number 61. Then, the warning signal sensing circuit 39 senses the warning signal from the warning device 38 and informs the control circuit 37 that it has received the warning signal from the warning device 38b.

From this time on, the control circuit 37 controls the selector circuit 32 and buffer memories 33a to 33d in such a manner that it causes the image picked up by the camera 31b to be stored in the buffer memory 33b at a rate of one out of two operations of storing the image selected by the selector circuit 32 into the buffer memories 33a to 33d.

As a result, the image with the next frame number 62 is stored in the buffer memory 33b and the image with frame number 63 is stored in the buffer memory 33c. The image with the next frame number 64 is stored in the buffer memory 33b again.

Similarly, the image with the frame number 65 is stored in the buffer memory 33d, the image with frame number 66 is stored in the buffer memory 33b, and the image with the frame number 67 is stored in the buffer memory 33a.

Similarly, from this point on, the image photographed by the camera 31b is stored in the buffer memory 33b at a rate of one out of two operations of storing the image selected by the selector circuit 33 into the buffer memories 33a to 33d.

When the number of the images stored in the buffer memories 33a to 33d has reached 15, they are read via the selector circuit 34 into the MPEG coding device 35, which codes them according to the MPEG standard. The resulting pictures are stored in the recording device 36.

Specifically, after the warning device 38b has given a warning signal, the speed at which the image obtained from the camera 31b is stored in the buffer memory 33b is three time as fast as the speed at which the images obtained from the other cameras 31a, 31c, 31d are stored in the buffer memories 33a, 33c, 33d, which increases the frequency of one GOP being coded.

When the recorded images are reproduced, the recording device 36 is connected to the MPEG decoding device 40. The MPEG decoding device 40 is connected to the display unit 41. The image on the selected channel is decoded according to the MPEG standard and the MPEG-decoded picture is displayed on the display unit 41.

In this case, since the images obtained from the camera 31b and stored in the buffer memory 33b are three times as many as those obtained from each of the other cameras 31a, 31c, 31d and stored in the buffer memories 33a, 33c, and 33d, the degree of watch on the channel with channel number 2 after the issue of the warning signal is increased.

The second embodiment has the advantage that an abnormality is sensed even without any watchman and watch on the abnormality with the cameras 33a to 33d is intensified automatically.

While in the second embodiment, the warning devices 38a to 38d are provided for the cameras 33a to 33d respectively and the channel on which the degree of watch is increased is determined automatically, such a channel may be determined manually.

Although in the first and second embodiments, the images are coded according to the MPEG standard, the present invention is not limited to MPEG coding and may be applied to any other compression coding as long as it uses frame correlation.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A multichannel image compression device comprising:
recording means for storing digital images on a plurality of channels in frames channel by channel into memories;
control means for performing control in such a manner that the digital images stored by the recording means into said memories increase in number on a specific channel; and
compression means for subjecting the digital images recorded by said recording means into said memories to compression coding by correlating frames channel by channel.

2. The multichannel image compression device according to claim 1, wherein said control means performs control in such a manner that, with the digital images on the plurality of channels being stored channel by channel by said recording means into said memories sequentially, the digital image on said specific channel and the digital images on the other channels are stored alternately in said memories.

3. The multichannel image compression device according to claim 1, wherein said control means allows said specific channel to be set manually out of the plurality of channels.

4. The multichannel image compression device according to claim 1, wherein said control means sets said specific channel automatically out of the plurality of channels according to the occurrence of a warning to indicate an abnormality.

5. The multichannel image compression device according to claim 1, wherein the digital images of the channels, which are stored in the memories by the recording means, are produced by a plurality of monitor cameras.

6. The multichannel image compression device according to claim 1, wherein said recording means includes switching means for selectively switching the digital images of the channels in units of one frame for each channel, when the digital images are stored in the memories.

7. The multichannel image compression device according to claim 1, wherein an output from said compression means is recorded in a DVD.

8. A multichannel image compression device comprising:
recording section for storing digital images on a plurality of channels in frames channel by channel into memories;
control section for performing control in such a manner that the digital images stored by the recording section into said memories increase in number on a specific channel; and
compression section for subjecting the digital images recorded by said recording section into said memories to compression coding by correlating frames channel by channel.

9. A multichannel image compression method comprising:
a recording step of storing digital images on a plurality of channels in frames channel by channel into memories;
a control step of performing control in such a manner that the digital images stored in said memories in the recording step increase in number on a specific channel; and
a compression step of subjecting the digital images recorded in said memories in said recording step to compression coding by correlating frames channel by channel.

10. The multichannel image compression method according to claim 9, wherein said control step performs control in such a manner that, with the digital images on the plurality of channels being stored channel by channel in said recording step into said memories sequentially, the digital image on said specific channel and the digital images on the other channels are stored alternately in said memories.

11. The multichannel image compression method according to claim 9, wherein said control step allows said specific channel to be set manually out of the plurality of channels.

12. The multichannel image compression method according to claim 9, wherein said control step sets said specific channel automatically out of the plurality of channels according to the occurrence of a warning to indicate an abnormality.
